(19) United States
(12) Patent Application Publication
(10) Pub. No.: US 2016/0337210 A1
(43) Pub. Date: Nov. 17, 2016

(54) Method and system for trouble ticketing

(71) Applicants: Oliver Helmut Koplin, Munchen (DE); Holger Otto Frohnauer, Rottenburg a. d. Laaber (DE)

(72) Inventors: Oliver Helmut Koplin, Munchen (DE); Holger Otto Frohnauer, Rottenburg a. d. Laaber (DE)

(73) Assignee: VIPCON GMBH & CO. KG, Munchen (DE)

(21) Appl. No.: 14/708,948

(22) Filed: May 11, 2015

(51) Int. Cl. H04L 12/24; G06Q 10/06; G06Q 30/00

(52) U.S. Cl. CPC H04L 41/5074; G06Q 30/016; G06Q 10/063114

(57) ABSTRACT

A method and system for monitoring and configuring at least one element of an IT infrastructure includes the following steps: receiving an incident trouble ticket from an input entity, said trouble ticket relating to at least one element of an IT infrastructure; analyzing, to which technology the incident trouble ticket relates; assigning the incident trouble ticket based on the technology to a system supporting the technology; converting the incident trouble ticket to an interoperable format; sending an forwarded trouble ticket in the interoperable format to a system adapted to support the technology; verifying, whether the forwarded trouble ticket was received by the system adapted to support the technology; and verifying, whether the forwarded trouble ticket is processed by the system adapted to support the technology.

### BACKGROUND OF THE INVENTION

1. Field of the Invention

The present invention relates to improved method and an improved system for handling trouble tickets.

2. Description of the Related Art

In IT services a trouble ticket is created if an infrastructure element, such as a printer, a router, a computer or the like, fails and is not available. In case of a malfunction of the IT infrastructure a user calls a help desk, which generally uses a so-called IT service management ITSM. The person in the help desk generates a so called trouble ticket which is then sent to the unit or partner in charge of resolving malfunctions of the infrastructure element not working properly. As soon as the malfunction is resolved the ITSM is informed such that the trouble ticket is cleared.

In a prior art system several different technologies have to be supported, wherein each different technology may require a different interface for a partner system or a unit for resolving the issue defined by the trouble ticket. In an IT infrastructure it may be necessary to involve a plurality of different partner systems or units to resolve issues, if adaptions or trouble shooting of a plurality of technologies are required.

In the prior art each partner implements different interfaces to the ITSM for receiving and acknowledging trouble tickets. In other words, the ITSM has to be changed, if IT elements are introduced that support or require a new technology. Therefore, additional interfaces have to be implemented in the ITSM. Sucinterfaces are intricate to implement and to test. Each technology may require a different event handler.

The above systems are commercially available under BMC Remedy TSM Suite and BMC Atrium Orchestrator.

Prior art systems cannot provide common quality standards for interfaces. There is no core function for centralized logging or determining platformwide KPIs as well as systemwide number of interface transactions. There is generally no mechanism for ensuring high availability of interfaces and security of transactions for avoiding data loss. Prior art systems generally do not provide asynchronous interface processing. There is no multilayer security model.

The object of the invention is to provide a method and a system that connects a plurality of systems, which are supporting an IT technology, to an ITSM.

### SUMMARY OF THE INVENTION

The object of the present invention is achieved by a method and system for processing a trouble ticket performing the steps of receiving an incident trouble ticket from an input entity, analyzing, to which technology the incident trouble ticket relates, assigning the incident trouble ticket based on the technology to a system supporting the technology, converting the incident trouble ticket to an interoperable format, sending a forwarded trouble ticket in the interoperable format to a system adapted to support the technology, verifying, whether the forwarded trouble ticket was received by the system adapted to support the technology, and verifying, whether the forwarded trouble ticket is processed by the system adapted to support the technology. The input entity may be an ITSM. The interoperable format may be a standard format, such as xml.

According to the present invention the ITSM as input entity needs to support only a single interface for generating trouble tickets and receiving acknowledgments or remedies. Further, the systems supporting the technology have to implement only a single interface in order to communicate with different types of ITSM.

The object of the present invention is also solved by a system for processing a trouble ticket having a trouble ticket receiver for receiving an incident trouble ticket, a trouble ticket analyzer for analyzing the incident trouble ticket, a trouble ticket assignor for assigning the incident trouble ticket, a trouble ticket converter for converting the incident trouble ticket in an interoperable format, a trouble ticket transmitter for transmitting a forwarded trouble ticket in the interoperable format to a system adapted to support the technology, a trouble ticket reception verifier for verifying, whether the forwarded trouble ticket was received by the system adapted to support the technology, and a trouble ticket procession verifier for verifying, whether the forwarded trouble ticket is processed by the system adapted to support the technology.

The invention is now explained with reference to the appended figures showing a non limiting and merely exemplary embodiment, wherein

### BRIEF DESCRIPTION OF THE FIGURES OF THE DRAWINGS

FIG. 1 shows processing of a trouble ticket sent from ITSM to a partner system.

FIG. 2 shows processing of communication from a partner system to an ITSM.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

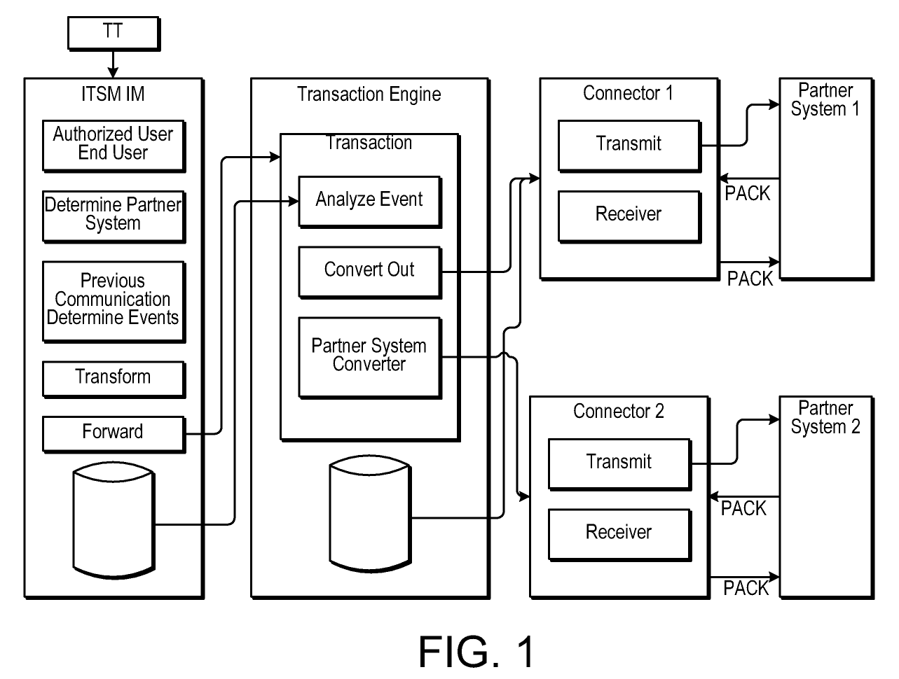

FIG. 1 shows a general overview over the inventive trouble ticket processing system 1. The trouble ticket system 1 comprises an ITSM incident management module IM.

When an incident trouble ticket TT is received by the incident management module IM from an input entity, in a first step an authorized user verification module verifies whether the trouble ticket TT was created by an authorized user. Authorized user may be human user working at a help desk and receiving information from users. An authorized user may also be another computer or network node, such as a monitoring tool. In an exemplary embodiment the authorized user verification module may be simply implemented by a white list and/or black list. By filtering unauthorized user the number of processed trouble tickets may be reduced to the actual necessary amount from a technical perspective.

In a next step the determine partner system module is determining, which partner system is responsible for resolving the issue defined in the incident trouble ticket TT. The determine partner system module verifies, which technology is reported to cause an error by the incident trouble ticket. Thereby the necessary partner system is selected. If it is not possible to determine the responsible partner system, the procedure ends and the incident trouble ticket remains in the local database of the incident management IM.

If a responsible partner system has been determined in the previous step, then the previous communication and determine event module verifies, whether the issue defined by the incident trouble ticket has been processed before. The incident trouble ticket may have been processed by the local organization before. If the issue defined in the trouble ticket has been processed by the local organization, the current incident trouble ticket is actually an update trouble ticket.

Therefore, the previous communication and determine event module transforms an update trouble ticket into a new trouble ticket in order to inform the partner system about the history of processing the issue defined by the trouble ticket. In other words, the originally created trouble ticket and the following update trouble tickets are all combined in a new created trouble ticket event.

The previous communication and determine event module creates a new trouble ticket event based on a new incident trouble ticket, if the issue defined in the trouble ticket has not been processed before by the ITSM or the partner system.

If the current incident trouble ticket TT has already been forwarded and the trouble ticket comprises new information about the subject defined therein, the previous communication and determine event module creates an update trouble ticket event.

Finally, the forward module forwards the event to a transaction engine.

The incident trouble ticket as modified is also stored in the local database of the incident management IM. Only trouble tickets that have to be processed by the local organization are notified to the local organization. If the determine partner system module has determined that a partner system is responsible for resolving the issue defined by the incident trouble ticket, the members of local organization are not informed about the incident trouble ticket.

The forward module forwards the event to the transaction engine as mentioned before. The event includes the responsible partner system, the event type such as create trouble ticket, update trouble ticket and the like.

With reference to FIG. 1 also the transaction engine is described, as mentioned before. After the incident trouble ticket TT is forwarded as an event to the transaction engine, the analyzing event module analyzes the event. For example, the analyze event module may access the database of the incident management IM and may collect all data necessary for processing the event in the database of the incident management IM. It is to be understood that depending on the event the analyze event module retrieves different data from the database of the incident management IM.

In a next step, the convert module converts the incident management IM data collected by the analyze event module in an interoperable format, such as XML.

If the partner system to which the forwarded trouble ticket is to be processed can process the inoperable format, the forwarded trouble ticket is passed to a first connector 1, which has a transmit module transmitting the forwarded trouble ticket to the partner system 1. As soon as the partner system 1 has received the forwarded trouble ticket, reception is acknowledged by a DACK (Delivery Acknowledge).

As soon as the partner system 1 has processed the trouble ticket, a PACK (Process Acknowledgment) is sent to the receiver of connector 1.

In case the partner system, to which the forwarded trouble ticket is to be forwarded cannot process the inoperable format, the trouble ticket to be forwarded is passed to the partner system converter module, which converts the data collected by the analyze event module, i.e. the trouble ticket to be forwarded, in a format supported by the partner system 2. Thereafter, the trouble ticket to be forwarded to the partner system 2 is passed to the connector 2 having a transmitter module transmitting the forwarded trouble ticket to the partner system 2, which acknowledges reception by a PACK. As soon as the partner system 2 has processed the trouble ticket, an acknowledgment PACK is sent to the receiver module of connector 2.

In case the determine partner system module determines that the incident trouble ticket has to be forwarded to a plurality of partner systems, a plurality of events are created by the previous communication and determine event module. These events may comprise a plurality of new trouble ticket events and a plurality of update trouble ticket events. It may be possible that a first partner system receives a new trouble ticket event, whereas a second partner system may receive an update trouble ticket event base on the same incident trouble ticket, if the incident listed in the trouble ticket was processed before by the first partner system and not processed before by the second partner system.

The events are forwarded by the forward module to the transaction engine. The transaction engine will process the events as described above as separate events and will forward separate forwarded trouble tickets to the appropriate connectors and partner systems.

The above scenario may take into account that a plurality of technologies may be involved for resolving an IT related problem in the ticket.

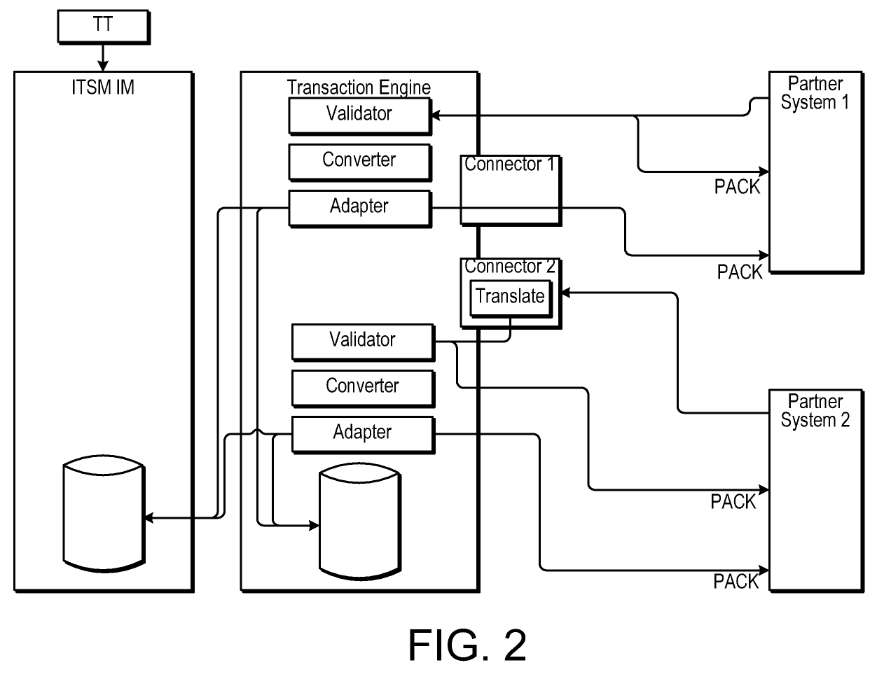

With reference to FIG. 2, communication from a partner system to the transaction engine and the incident management IM is described.

The partner system 1 sends an event to the validator of the transaction engine. The validator verifies, whether the partner system 1 used the correct security information, such as user name and password. Further, the validator verifies whether the partner system 1 is authorized to use the method indicated by the message creating the event. Finally, the validator verifies, whether the data transmitted by partner system 1 comprises the correct syntax, such as that all required data is submitted and that each element has a value in an allowed range. As soon as the validator has validated the message received from partner system 1, a PACK is transmitted to partner system 1.

Thereafter, the converter converts the received data into a format required by the incident management IM. Then, the data received from partner system 1 and the converted data is forwarded to the adapter. The adapter forwards the converted data, which are based on the inbound trouble ticket, to the database of the incident management IM. Further, the adapter stores the data received from partner system 1 in the data base of the transaction engine. The adapter sends via the connector 1 the PACK to partner system 1.

In case a partner system 2 does not use the interoperable format of the transaction engine, a connector 2 comprises a translate module that translate the data received from partner system 2 into the interoperable data format of the transaction engine 2. Thereafter, the steps described before are performed by the transaction engine on the translated inbound trouble ticket received from partner system 2.

With reference to FIG. 1 further details of the invention are described. The incident trouble ticket TT may create a so called incident request, which is the electronic documentation of an operation failure related to the IT infrastructure. The incident indicated by the incident request is to be resolved as quick as possible to restore the IT infrastructure.

An incident work info lists the steps to be performed for resolving the incident indicated in the incident request.

An incident task lists tasks to be performed by third parties in order to restore the IT infrastructure.

An incident relation to another incident indicates that two incidents are caused by the same technical problem.

An incident relation to at least one element of the infrastructure defines the relation of the trouble ticket or incident to an element of the infrastructure, such as a router.

An update of an incident request updates the incident request, such as after changing the priority or assigning the incident to a work group. The update of an incident task updates the steps necessary for resolving the problem in the IT infrastructure.

Incident relations to at least one element of the IT infrastructure may be removed.

The above incident events may be stored in the data base of the transaction engine.

With reference to FIG. 2 the message received by the partner system may request to create a new trouble ticket, to update an existing trouble ticket, to combine at least two trouble tickets, to delete a trouble ticket, to create a task, to delete a task and/or to combine at least two tasks. After converting the message from the partner system the data base of the transaction engine is updated and a message is sent from the transaction engine to the incident management to update the data base of the incident management.

Now, failure scenarios and recover scenarios are described. If the authorize user module, the determine partner system module or the previous communication and determine event module fail to process an incident trouble ticket TT, an input entity sending the incident trouble ticket TT receives a warning message from the incident management IM. Additionally, the incident trouble tickets received by the incident management are saved in the data base of the incident management and indicated by the flag failed. As soon as the authorized user module, the determine partner system module and the previous communication and determine event module resume processing incident trouble tickets TT the incident trouble ticket indicated by the failed flag failed are processed. These trouble tickets are forwarded as events with high priority to the transaction engine.

If a connector cannot send a forwarded trouble ticket to a partner system or if the connector does not receive an acknowledgement PACK, the forwarded trouble ticket is stored in the data base of the transaction machine. The connector will retry to transmit the forwarded trouble ticket to the partner system. If the connector cannot transmit the forwarded trouble ticket for a predetermined number of retries, the forwarded trouble ticket is stored in data base of the transaction machine and indicated with the failed flag. As soon as the transaction engine or the connector receive a message from the partner system indicating availability of the partner system or as soon as the connector or the transaction engine determine that the partner system is available, the forwarded trouble tickets indicated with the failed flag are transmitted to the partner system.

The present invention provides a method and system for improving the availability of IT infrastructure by handling trouble tickets input in an input entity and transmitting them to the partner system for resolving the failure of the IT infrastructure. The present invention can also receive trouble tickets from a partner system, assign it to a trouble ticket received from the input entity and combine the trouble tickets and inform the input entity about the combined trouble ticket. Thereby, availability of the IT infrastructure can be improved.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for monitoring and configuring at least one element of an IT infrastructure, said method having the following steps:
receiving an incident trouble ticket from an input entity, said trouble ticket relating to at least one element of an IT infrastructure;
analyzing, to which technology the incident trouble ticket relates;
assigning the incident trouble ticket based on the technology to a system supporting the technology;
converting the incident trouble ticket to an interoperable format;
sending a forwarded trouble ticket in the interoperable format to a system adapted to support the technology;
verifying, whether the forwarded trouble ticket was received by the system adapted to support the technology; and
verifying, whether the forwarded trouble ticket is processed by the system adapted to support the technology.

2. The method according to claim 1, further comprising the step of converting the incident trouble ticket in the interoperable format into a technology specific format before sending the forwarded trouble ticket to the system adapted to support the technology.

3. The method according to claim 1, wherein the step of verifying, whether the forwarded trouble ticket was received by the system adapted to support the technology, and the step of verifying, whether the forwarded trouble ticket is processed by the system adapted to support the technology, include the step of receiving an acknowledgement from the system supporting the technology.

4. The method according to claim 1, wherein
the step of analyzing to which technology the incident trouble ticket relates, includes the step of analyzing to which necessary technologies the incident trouble ticket relates;
the step of assigning the incident trouble ticket based technology to a system supporting the technology includes the step of assigning the incident trouble ticket based on the necessary technologies to a plurality of systems supporting a necessary technology; and
the step of sending the forwarded trouble ticket to a system adapted to support the technology includes the step of sending the forwarded trouble ticket to a plurality of systems adapted to support at least one of the necessary technologies.

5. The method according to claim 1, wherein the interoperable format is an xml format.

6. The method according to claim 1, wherein the method further includes the step of verifying the incident trouble ticket.

7. The method according to claim 6, wherein the step of verifying the incident trouble ticket includes at least one of the following steps:
verifying, whether the operator is an authorized user;
verifying, whether the operator is authorized to create the trouble ticket;
verifying, whether trouble ticket can be assigned to an existing system supporting the technology;
verifying the format of the trouble ticket;
verifying, whether the trouble ticked has been created for an authorized purpose;
verifying, whether the assigned system is enabled to support the technology.

8. The method according to claim 1, further comprising the step of analyzing, which event is triggered by the by the incident trouble ticket.

9. The method according to claim 8, wherein the step of analyzing, which event is triggered by the incident trouble ticket includes at least one on the following steps:
creating an incident request;
creating an incident work info;
creating an incident task;
creating an incident relation to another incident;
creating an incident relation to at least one element of the infrastructure;
update of an incident request;
update of an incident task;
removing an incident relation to another event;
removing an incident relation to at least one element of the infrastructure.

10. The method according to claim 1, further comprising the step of
receiving a message from the system supporting the technology;
acknowledging the receipt of the message; and
performing an action triggered by the message.

11. The method according to claim 8, wherein the step of performing an action triggered by the message comprises at least one of the following steps:
creating a new trouble ticket;
updating a trouble ticket;
combining at least two trouble tickets;
deleting a trouble ticket;
creating a task;
deleting a task; and
combining at least two tasks.

12. The method according claim 8, further comprising the step of after the action has been terminated acknowledging to the system supporting the technology that the action has been performed.

13. The method according to claim 10, further comprising the step of transmitting the information about the performed action to the input entity.

14. The method according to claim 11, wherein the step of transmitting the information about the performed action to the input entity includes the step of transmitting information about the trouble ticket or information about the task.

15. The method according to claim 1, further comprising the following steps:
determining that the step of verifying, whether the forwarded trouble ticket was received by the system supporting the technology failed;
waiting a predetermined period; and
resending the forwarded trouble ticket to the system supporting the technology.

16. The method according to claim 15, further comprising the step of indicating the forwarded trouble ticked as failed, if the step of resending failed for a predetermined number of repetitions.

17. The method according to claim 16, further comprising the steps of
determining that a message is received from the system supporting the technology; and
resending the forwarded trouble ticket to the system supporting the technology that has been indicated as failed.

18. The method according to claim 10, further comprising the step of
determining that it is not possible to preform the action triggered by the message;
indicating to the system supporting the technology that it is not possible to preform the action triggered by the message; and
receiving the message from the system supporting the technology after a predetermined period again, if it has been determined that it is not possible to preform the action triggered by the message.

19. The method according to claim 1, further comprising the steps of
determining that one of the steps of analyzing, to which technology the incident trouble ticket relates, of assigning the incident trouble ticket based on the technology to a system supporting the technology and of converting the incident trouble ticket to an interoperable format, failed;
transmitting a message to the input entity indicating that an error occurred; and
indicating the incident trouble ticket as failed.

20. The method according to claim 19, further comprising the steps of
determining that the steps of analyzing, assigning and converting the incident trouble ticket can be performed;
analyzing, to which technology the incident trouble ticket indicated as failed relates;
assigning the incident trouble ticket indicated as failed based on the technology to a system supporting the technology;
converting the incident trouble ticket indicated as failed to an interoperable format.

21. A system for processing a trouble ticket, including
a trouble ticket receiver for receiving an incident trouble ticket;
a trouble ticket analyzer for analyzing the incident trouble ticket;
a trouble ticket assignor for assigning the incident trouble ticket;
a trouble ticket converter for converting the incident trouble ticket in an interoperable format;
a trouble ticket transmitter for transmitting a forwarded trouble ticket in the interoperable format to a system adapted to support the technology;
a trouble ticket reception verifier for verifying, whether the forwarded trouble ticket was received by the system adapted to support the technology; and
a trouble ticket procession verifier for verifying, whether the incident trouble ticket is processed by the system adapted to support the technology.

22. The system according to claim 15, wherein the trouble ticket converter coverts the trouble ticket in the interoperable format in to a technology specific format before the trouble ticket transmitter transmits the trouble ticket to the system adapter to support the technology.
